(19) United States
(12) Patent Application Publication
(10) Pub. No.: US 2024/0359583 A1
(43) Pub. Date: Oct. 31, 2024

(54) MACHINE LEARNING DRIVEN FRAMEWORK FOR VIRTUAL POWER PLANT (VPP) ENERGY MANAGEMENT

(71) Applicant: Banpu Innovation & Ventures LLC, Wilmington, DE (US)

(72) Inventor: Othman Elkhomri, Wilmington, DE (US)

(73) Assignee: Banpu Innovation & Ventures LLC, Wilmington, DE (US)

(21) Appl. No.: 18/139,597

(22) Filed: Apr. 26, 2023

(51) Int. Cl. B60L 53/64; B60L 53/63

(52) U.S. Cl. CPC B60L 53/64; B60L 53/63

(57) ABSTRACT

A method of managing a virtual power plant (VPP) and power distribution between a power grid, a battery storage system, an electric vehicle (EV) charging station, and a power plant, includes: obtaining a first data set including information from each of the power grid, the battery storage system, the EV charging station, and the power plant; training a VPP simulation model based on the first data set using a machine learning algorithm; obtaining a second data set including information from each of the power grid, the battery storage system, the EV charging station, and the power plant; determining power condition information based on the second data set and VPP simulation model; generating a power schedule, based on the VPP simulation model and the power condition information; and transmitting a command based on the power schedule.

### BACKGROUND

An intelligent energy system is defined as an approach in which intelligent electricity, thermal, and gas grids are combined with storage technologies and coordinated to identify synergies between them in order to achieve an optimal solution for each individual sector as well as for the overall energy system. In aggregated systems, different power sources and power consumption units could potentially offer flexibility to the power system. However, in aggregated systems, power production from each power source may not be directly controlled. For example, the power generated by solar power plants (i.e., one or more arrays of solar panels) and wind power plants is dependent on weather conditions, time of day, and/or time of year. To maximize utilization of these variable power sources and minimize the risk of inefficient power supply usage at any given time, techniques for efficiently storing and allocating power throughout an intelligent grid are required.

A virtual power plant is a system that connects different components of an intelligent grid ecosystem (power sources, power storage technologies (e.g., battery systems, electric vehicle batteries), and power consumers (e.g., buildings, electric vehicles, intelligent systems)) and coordinates optimal control solutions for the overall power ecosystem. In other words, the aim of the virtual power plant control system is to manage the power flow through the grid components in order to increase the economic performance and sustainability of the grid.

### SUMMARY

In general, embodiments of the invention relate to a method of managing a virtual power plant (VPP) and power distribution between a power grid, a battery storage system, an electric vehicle (EV) charging station, and a power plant. The method includes: obtaining a first data set including information from each of the power grid, the battery storage system, the EV charging station, and the power plant; training a VPP simulation model based on the first data set using a machine learning algorithm; obtaining a second data set including information from each of the power grid, the battery storage system, the EV charging station, and the power plant; determining power condition information for each of the power grid, the battery storage system, the EV charging station, and the power plant based on the second data set and VPP simulation model; generating a power schedule, based on the VPP simulation model and the power condition information, that controls: power exports from each of the power grid, the battery storage system, the EV charging station, and the power plant; and power imports into each of the power grid, the battery storage system, and the EV charging station; and transmitting a command to adjust an operation of at least one of the power grid, the battery storage system, the EV charging station, and the power plant based on the power schedule.

In addition, embodiments of the invention relate to a virtual power plant (VPP) controller that manages power distribution between a power grid, a battery storage system, an electric vehicle (EV) charging station, and a power plant. The VPP controller includes: a processor configured as a power grid interface that communicates with the power grid, a battery storage interface that communicates with the battery storage system, an EV interface that communicates with the EV charging station; and a power plant interface that communicates with the power plant. The VPP controller further includes a memory storing instructions that, when executed, cause the processor to: obtain a first data set including information from each of the power grid, the battery storage system, the EV charging station, and the power plant; train a VPP simulation model based on the first data set using a machine learning algorithm; obtain a second data set including information from each of the power grid, the battery storage system, the EV charging station, and the power plant; determine power condition information for each of the power grid, the battery storage system, the EV charging station, and the power plant based on the second data set and VPP simulation model; generate a power schedule, based on the VPP simulation model and the power condition information, that controls: power exports from each of the power grid, the battery storage system, the EV charging station, and the power plant; and power imports into each of the power grid, the battery storage system, and the EV charging station; and transmit a command, via at least one of the power grid interface, the battery storage interface, the EV interface, and the power plant interface, to adjust an operation of at least one of the power grid, the battery storage system, the EV charging station, and the power plant based on the power schedule.

In addition, embodiments of the invention relate to non-transitory computer readable medium storing instructions executable by a computer processor, the instructions comprising functionality for: obtaining a first data set including information from each of the power grid, the battery storage system, the EV charging station, and the power plant; training a VPP simulation model based on the first data set using a machine learning algorithm; obtaining a second data set including information from each of the power grid, the battery storage system, the EV charging station, and the power plant; determining power condition information for each of the power grid, the battery storage system, the EV charging station, and the power plant based on the second data set and VPP simulation model; generating a power schedule, based on the VPP simulation model and the power condition information, that controls: power exports from each of the power grid, the battery storage system, the EV charging station, and the power plant; and power imports into each of the power grid, the battery storage system, and the EV charging station; and transmitting a command to adjust an operation of at least one of the power grid, the battery storage system, the EV charging station, and the power plant based on the power schedule.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a comparative example of a conventional power system.

FIGS. 2A-2D show examples of improvements to power management in an intelligent grid system in accordance with one or more embodiments.

FIG. 3A shows an example VPP intelligent grid system in accordance with one or more embodiments.

FIG. 3B shows an example power grid in accordance with one or more embodiments.

FIG. 3C shows an example battery storage system in accordance with one or more embodiments.

FIG. 3D shows an example electric vehicle charging system in accordance with one or more embodiments.

FIG. 3E shows an example power plant in accordance with one or more embodiments.

FIG. 4 shows an example VPP intelligent grid system in accordance with one or more embodiments.

FIG. 5 shows a flowchart in accordance with one or more embodiments.

FIG. 6 shows an implementation example in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

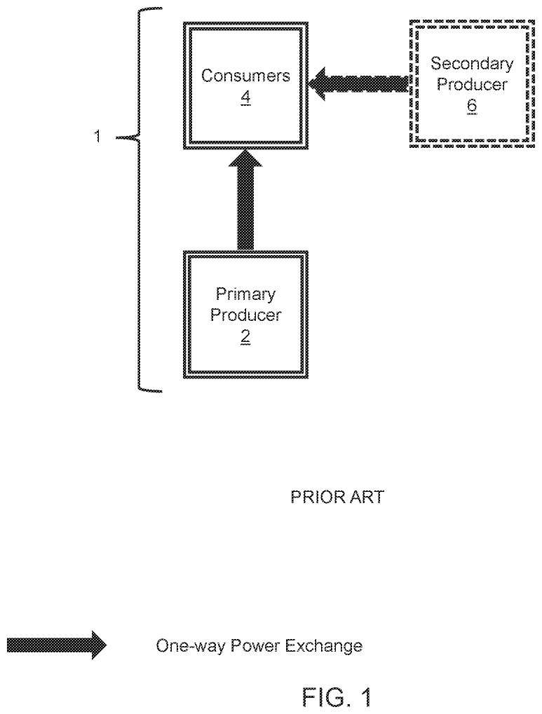

FIG. 1 shows a comparative example of a conventional power system 1. A primary power producer 2 may include one or more power generation subsystems (e.g., generators) that provide power to consumers 4. The primary power producer 2 regulates power capacity and output levels (e.g., by turning on/off a number of generators) based on an estimate of demand from the consumers 4. When demand is expected to exceed a total capacity of the primary power producer 2, a secondary power producer 6 may be activated to supply enough power to ensure continuous service to the consumers 4.

This conventional control approach relies on the ability to accurately estimate demand and reliably activate/connect a number of power generation subsystems to meet the estimated demand. However, this conventional approach is difficult to execute in power systems that include power plants with time-varying output and that are influenced by environmental factors beyond the direct control on an operator (e.g., solar power plants, wind power plants, hydropower plants). For example, the maximum output of a solar power plant is during the peak of incident solar radiation from the sun (i.e., near the middle of a given day), while peak consumer demand may occur in the evening after the sun has set.

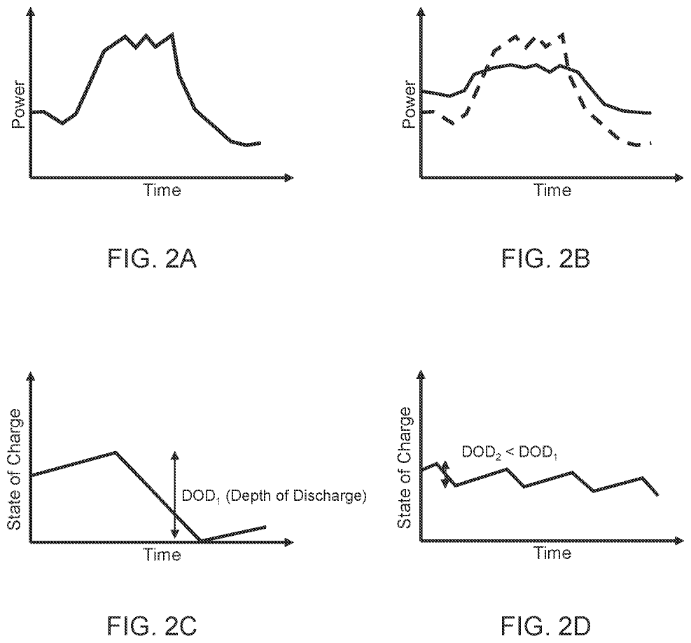

FIGS. 2A-2D show examples of improvements to power management in an intelligent grid system in accordance with one or more embodiments.

In FIG. 2A, power output for a given production facility has peak period during a given timeframe (e.g., day, week, year). Increasing production to peak levels or maximum capacity generally requires straining the production facility and staff, which results in higher maintenance costs. As shown in FIG. 2B, peak shaving and load leveling may be employed by a VPP to maintain utilization of the production (e.g., total power produced within the timeframe is unchanged) but reduce strain and extend the lifetime of the production facility. To account for the lower peak production caused by peak shaving, the VPP leverages the capacity and flexibility of the intelligent grid ecosystem by managing the power flow from other production facilities. The VPP controller would be able to optimize the power flow (e.g., reducing the electric energy cost by selecting the most efficient source corresponding to the period of peak shaving) such that the power quality could be increased.

In FIG. 2C, the state of charge (SOC) of a battery storage system is shown being depleted during a period of peak usage over a given timeframe. The depth of discharge (DOD) is the difference in the SOC over the period of use. Batteries age much more slowly with lower DoD (e.g., logarithmic relationship). Therefore, increasing the lifetime and cost-effectiveness of the battery storage system can be achieved in part by minimizing large DOD events and delaying costly battery replacements. As shown in FIG. 2D, an ideal charge-discharge profile keeps the SOC far from reaching 0% and 100%, with low DoD, to dramatically the battery life (measured in a number of charge/discharge cycles).

To improve performance, such as implementing the above non-limiting examples in FIGS. 2A-2D, a VPP intelligent grid system employs a control system able to exploit information describing the predicted dynamics of subsystems composing the intelligent grid system. The VPP controller utilizes a training dataset from each of the connected components of the intelligent grid system to train a VPP simulation model that can optimally coordinate the power distribution between the components. The capabilities of the VPP simulation model may be further extended by using a predictive control policy to account for the dynamic behavior of the components of the power ecosystem.

In general, embodiments of the disclosure include a VPP controller, a method, and a non-transitory computer readable medium storing instructions executable by a computer processor for managing power distribution in an intelligent grid system (e.g., between a power grid, a battery storage system, an electric vehicle (EV) charging station, and a power plant) by training and applying a VPP simulation model.

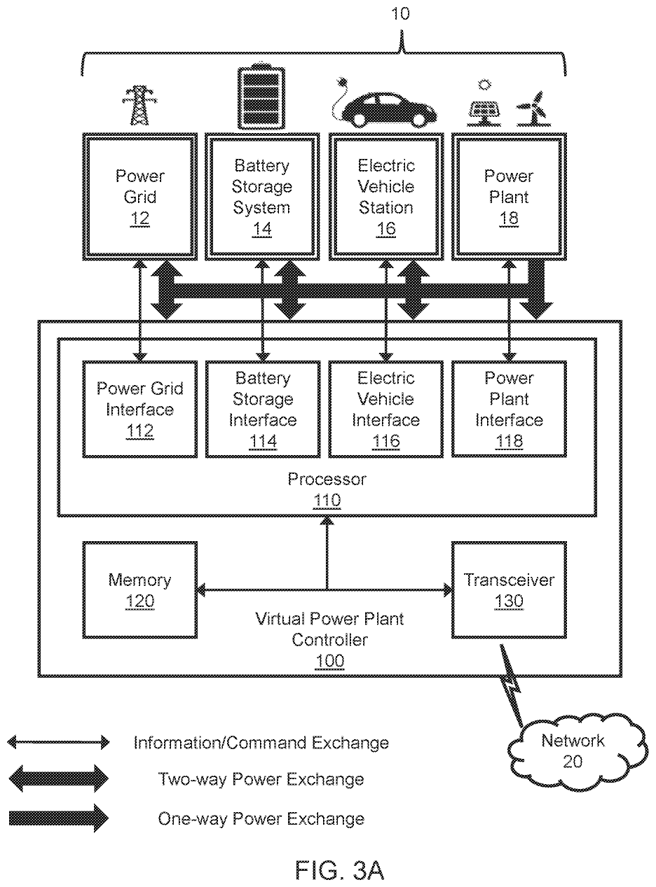

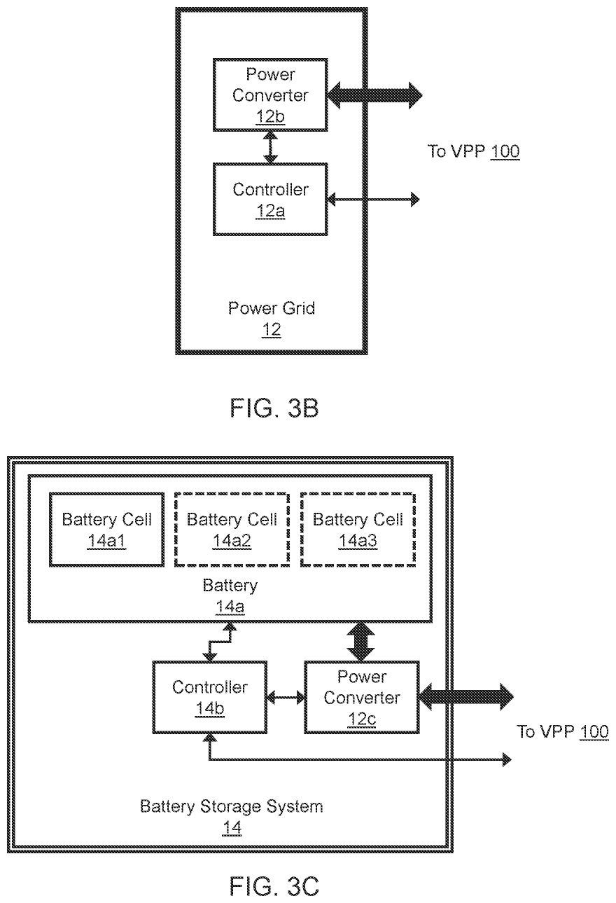

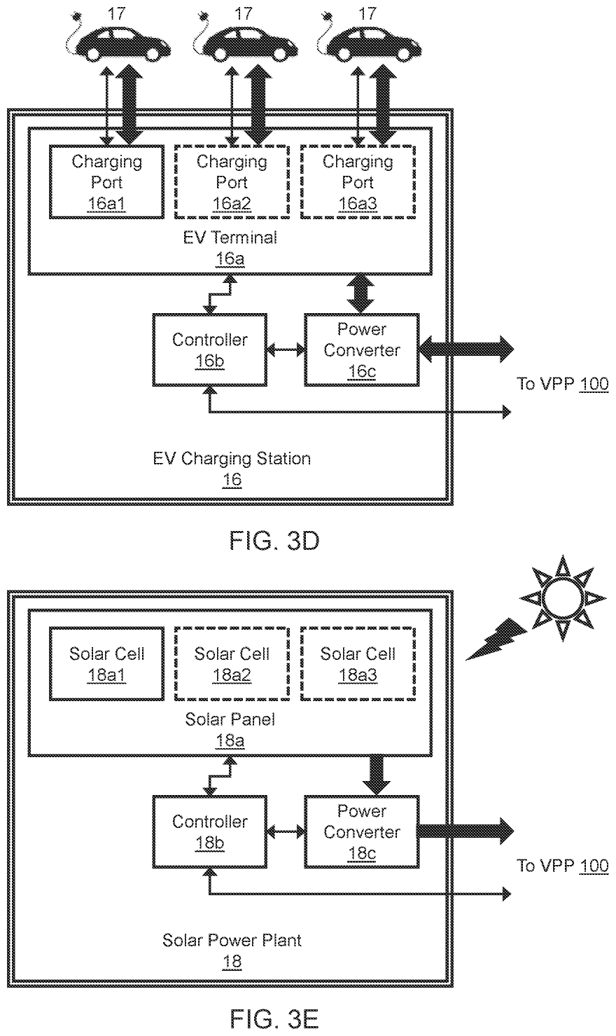

FIG. 3A shows an example VPP intelligent grid system 10 in accordance with one or more embodiments.

The VPP controller 100 connects different power sources and power consumption subsystems. As shown in FIG. 3A, a VPP intelligent grid system 10 includes a power grid 12, a battery storage system 14, an electric vehicle (EV) station 16, a power plant 18, a network 20, and the VPP controller 100. The power grid 12 is a unique subsystem in that it can deliver any required amount of power to the VPP intelligent grid system 10 (e.g., an alternating current (AC) power network). However, the VPP controller 100 seeks to minimize an economic cost of the power grid 12 (e.g., reduce usage and dependence on the power drawn from power grid 12) by optimally managing different power sources and energy storage systems.

To guarantee capacity and reliability requirements for any power consuming subsystems connected to the VPP intelligent grid system 10, the VPP intelligent grid system 10 may include a battery storage system 14 that stores and provides power on demand in an optimal manner. Furthermore, a power plant 18 (e.g., a solar power plant providing power from a solar radiation source) may deliver power to the VPP intelligent grid system 10 to further reduce the amount of power utilized from the power grid 12. Furthermore, certain end-user subsystems equipped with batteries (e.g., EVs and home battery systems) may be utilized by the VPP intelligent grid system 10 to store or release power.

Each of the components of the VPP intelligent grid system 10 is described in further detail below.

The VPP controller 100 has multiple components, and may include, for example, a processor 110, a memory 120, and a transceiver 130. The processor 110 may be an integrated circuit (e.g., one or more cores, or micro-cores) for processing instructions and data sets, training a VPP simulation model, determining power condition information, and generating control commands, as described in further detail below. The memory 120 may be random access memory (RAM), cache memory, flash memory, or a storage drive that stores information for the VPP controller 100. The transceiver 130 may be a wired or wireless communications circuit (e.g., data port, antenna(s) array, communications bus) that allows the VPP controller 100 to communicate with an external device, such as a user device or a network 20 that can provide supplemental information to guide or control the VPP controller 100 from outside of the feedback loops in the VPP intelligent grid 10. Although the VPP controller 100 in FIG. 3A is shown as having three components (110, 120, and 130), in other embodiments of the invention, the VPP controller 100 may have more components (e.g., integrated memory, clock, analog to digital converter, communication bus) or fewer components. Furthermore, the functionality of each component described above may be shared among multiple components or performed by a different component. For example, each component (110. 120, and 130) may be utilized multiple times in serial or parallel to carry out repeated, iterative, or parallel operations.

The VPP controller 100 may also include one or more input device(s) (not shown), such as a button, touchscreen, camera, microphone, or any other type of input device for the user to provide information directly to the VPP controller 100 rather than through the transceiver 130. Further, the VPP controller 100 may include one or more output device(s) (not shown), such as a screen (e.g., a liquid crystal display (LCD), light emitting diode (LED) display, organic light emitting diode (OLED) display, or any other display device to provide information directly to the user rather than through the transceiver 130. One or more of the output device(s) may be the same or different from the input device(s). The VPP controller 100 may connect to a network 20 (e.g., a local area network (LAN), a wide area network (WAN) such as the Internet, mobile network, or any other type of network) via the transceiver 130 to exchange information between the VPP controller 100 and any device external to the VPP intelligent grid 10.

Further, one or more processing elements of the VPP controller 100 may be located at a remote location and may be connected to the other elements over the network 20. For example, one or more embodiments of the invention may be implemented by spreading the information processing across a distributed system having a plurality of nodes that include distinct computing and storage devices (i.e., cloud computing). Each node may correspond to a computer processor with associated physical memory. Each node may alternatively correspond to a computer processor or micro-core of a computer processor with shared memory and/or resources.

Software instructions executed by the VPP controller 100 may be in the form of computer readable program code to perform embodiments of the invention and may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

The processor 110 of the VPP controller 100 is connected with subsystems of the VPP intelligent grid components (i.e., local controllers/processors) to aid in controlling each intelligent grid component. The goal of the processor 110 is to define set-points that control power flow between each VPP intelligent grid component. In one or more embodiments, processor 110 of the VPP controller 100 is the centralized policy manager for the different VPP intelligent grid component. The processor 110 has multiple functional components, and may include, for example, a power grid interface 112, a battery storage interface 114, an EV interface 116, and a power plant interface 118.

The power grid interface 112 communicates with the power grid 12 to exchange power grid information (e.g., a reference power level, connection type/status information, price information) and consequent control commands (e.g., power requests, shut-down/disconnect requests). Furthermore, the power grid interface 112 contributes to the training of a VPP simulation model by modelling the power grid 12 according to the power grid specifications and operating conditions.

The battery storage interface 114 communicates with the battery storage system 14 to exchange battery condition information (e.g., state of charge information, connection type/status information, battery charge cycle number) and consequent control commands (e.g., power requests, shut-down/disconnect requests). Furthermore, the battery storage interface 114 contributes to the training of a VPP simulation model by modelling the battery storage system 14 according to the battery specifications and operating conditions.

The EV interface 116 communicates with the EV charging station 16 to exchange EV information (e.g., EV power levels, connection type/status information, EV charging price information) and consequent control commands (e.g., power requests, shut- down/disconnect requests). Furthermore, the EV interface 116 contributes to the training of a VPP simulation model by modelling the EV charging station 16 according to its specifications and operating conditions (e.g., fast charging or slow charging station).

The power plant interface 118 communicates with the power plant 18 to exchange information (e.g., solar power conversion efficiency parameters, solar panel health information, connection type/status information, weather information) and consequent control commands (e.g., power requests, shut-down/disconnect requests). Furthermore, the power plant interface 118 contributes to the training of a VPP simulation model by modelling the power plant 18 according to its specifications and operating conditions.

FIG. 3B shows an example power grid in accordance with one or more embodiments.

The power grid 12 of the VPP intelligent grid system 10 includes the infrastructure of a power network that can import any required amount of power to the VPP intelligent grid system 10. Further, when required or financially desirable, power can be exported (i.e., sold) to the power grid 12 by the VPP controller 100.

The power grid 12 includes a controller 12a (e.g., a processor) that communicates with the VPP controller 100 to coordinate the export and import of power to and from the power grid 12. The controller 12a controls a power converter 12b that facilitates the export and import of power between the power grid 12 and the rest of the VPP intelligent grid system 10. Note, the power flow is bidirectional. Further, the communication link between the controller 12a and the power grid interface 112 of the VPP controller 100 is bidirectional to exchange power grid information (e.g., a reference power level, connection type/status information, price information) and consequent control commands.

The power converter 12b may be an AC/DC power converter capable of operating in both rectified and inverter modes in order to permit the power to flow from/to the power grid 12 and the VPP intelligent grid system 10. The power converter 12b may switch operational modes based on control information received from the VPP controller 100. For example, the power converter 12b may have a bidirectional AC/DC power converter topology. It transfers power between a three-phase AC voltage supply and a DC voltage bus. The power converter 12b may comprise six transistors (e.g., IGBT-Diode switches) connected with the three-phase AC voltage supply through inductance-resistance series filters. A DC capacitor may be connected across the DC voltage bus to keep the voltage constant. The bidirectional AC-DC converter operates in two modes. The first mode is rectifier mode, in which the bidirectional AC-DC converter operates as a front-end rectifier and allows power transfer from the three-phase AC voltage end to the DC voltage bus. The second mode is inverter mode, in which the bidirectional AC-DC converter operates as a voltage source inverter and allows power flow from DC voltage bus to the three-phase AC voltage.

The control of power converter 12b may be based on voltage-oriented control (VOC) scheme, which decomposes the active and reactive power in stationary α-β coordinate and synchronizes the powers with rotating d-q reference frames by characterizing the current control loops using proportional integral (PI) controllers. Moreover, a virtual-flux-oriented control could be considered which also uses the PI controllers. The major limitation of these control schemes is tuning the PI controllers which further affects the coordinate transform accuracy.

Furthermore, a direct power control (DPC) scheme may be applied for grid-tied AC-DC converter based on the direct torque control (DTC) principle, which also uses the PI controllers. In order to improve the performance of the power converter 12b, a look-up table (LUT) based direct power control (DPC) scheme may be implemented. In these policies, the switching action of the power converter 12b may be performed based on a predefined switching state table on the basis of active and reactive power characteristics. This look-up table-based DPC method may produce undesirable harmonic spectrums. Alternatively, different control policies may be employed (e.g., Sliding Mode, Fuzzy Logic, or Model Predictive Control).

In one or more embodiments, the power converter 12b may further include a DC/DC power converter for voltage stepping or converting between different voltage levels of different components in the VPP intelligent grid system 10.

FIG. 3C shows an example battery storage system in accordance with one or more embodiments.

The battery storage system 14 includes one or more batteries 14a that represent a power storage system for accumulating or releasing power from/to the VPP intelligent grid system 10. Each battery 14a includes one or more battery cells 14a1-3 operating together for guaranteeing the required storage capacity of the entire battery 14a. The battery 14a may be Lithium-based. However, embodiments of the present invention are not limited to Lithium-based batteries and any appropriate rechargeable battery technology or chemistry may be employed by the battery storage system 14.

The battery storage system 14 is scalable to any appropriate facility size with large capacity batteries play a key role in future energy scenarios with fluctuating supply. For example, electric vehicle batteries may be utilized as a “microscale” battery storage system 14 for a household (e.g., off-grid homes). On the other hand, the battery storage system 14 may be scaled up to massive arrays of battery banks to help power large scale commercial or manufacturing facilities. The battery storage system 14 may be charged from the power grid 12 when the price of electricity is cheaper (i.e., below a reference energy cost) to achieve load leveling and peak shaving in the power grid 12 consumption in a cost effective manner.

The battery storage system 14 includes a controller 14b (e.g., a processor) that regulates the power flow between battery cells 14a1-3 as well as charging and discharging phases according to battery specifications and operating conditions. Furthermore, the controller 14b communicates with the VPP controller 100 to coordinate the export and import of power to and from the battery 14a. The controller 14b controls a power converter 14c that facilitates the export and import of power between the battery 14a and the rest of the VPP intelligent grid system 10. Note, the power flow is bidirectional, due to the possibility to store and release power from/to the VPP intelligent grid system 10 according to instantaneous operating conditions. Further, the communication link between the controller 14b and the battery storage interface 114 of the VPP controller 100 is bidirectional to exchange battery condition information (e.g., state of charge information, connection type/status information, battery charge cycle number) and consequent control commands.

Similar to the power converter 12b, the power converter 14c may be an AC/DC power converter capable of operating in both rectified and inverter modes in order to permit power flow between the battery 14a and the power grid 12 of the VPP intelligent grid system 10. Furthermore, the power converter 14c may include a DC/DC power converter for voltage stepping or converting between different voltage levels of different components in the VPP intelligent grid system 10.

FIG. 3D shows an example EV charging station in accordance with one or more embodiments.

The EV charging station 16 includes one or more EV terminals 16a that connect to EVs 17. Each EV terminal 16a may include one or more charging port 16a1-3 for charging or discharging a single EV 17. While an EV 17 typically relies on the VPP intelligent grid system 10 as power provider, as discussed above, the battery within the EV 17 may also be used as a “microscale” battery storage system 14 to provide power back to the VPP intelligent grid system 10 through the EV terminal 16a. For example. when financially desirable (e.g., electricity prices surge during high demand periods), an EV 17 can act as a power source in the VPP intelligent grid system 10.

Because the EVs are generally expected to be grid-connected and available for long periods of the time (e.g., connected at home overnight or connected in a parking lot during business hours) with a high degree of flexibility, an EV 17 can function as a quick-response power storage unit with bi-directional power flow capabilities. This flexibility can support a set of power services to influence the timing and rate of power distribution between EV battery and the VPP intelligent grid system 10 to yield benefits for the user, system, and society. For example, these services could involve frequency regulation, synthetic inertia, adaptive charging, network balancing, overvoltage management, line overloading, charging flexibility, and management.

The EV charging station 16 includes a controller 16b (e.g., a processor) that communicates with the VPP controller 100 to coordinate the export and import of power to and from the EV terminal 16a. The controller 16b controls a power converter 16c that facilitates the export and import of power between the EV terminal 16a and the rest of the VPP intelligent grid system 10. Note, the power flow is bidirectional. Further, the communication link between the controller 16b and the EV interface 116 of the VPP controller 100 is bidirectional to exchange EV information (e.g., EV power levels, connection type/status information, EV charging price information) and consequent control commands. The EV information may further include a connection schedule (user generated or tracked by the EV terminal 16a) for when the EV 17 is expected to be connected to the system. Furthermore, the EV information may include a user-defined amount of power and/or conditions (e.g., price, minimum maintained charge, maximum depth of discharge) under which power is allowed to be extracted from the EV 17.

Similar to the power converter 12b, the power converter 16c may be an AC/DC power converter capable of operating in both rectified and inverter modes in order to permit power flow between the EV terminal 16a and the power grid 12 of the VPP intelligent grid system 10. Furthermore, the power converter 16c may include a DC/DC power converter for voltage stepping or converting between different voltage levels of different components in the VPP intelligent grid system 10. Furthermore, EV charging stations 16 may be deployed with one or more types of power converters 16c with different capabilities (e.g., peak power ratings) to provide further flexibility and granularity to the above references support services.

FIG. 3E shows an example power plant in accordance with one or more embodiments.

In one or more embodiments, the power plant is a solar power plant 18. This type of energy source is advantageous to include in a VPP intelligent grid system 10 because of the low maintenance requirements, limited infrastructure installation cost (e.g., installation on roofs without audible noise during operations), and predictable power dynamics over required control horizons. In particular applications, the solar power plant 18 could be considered to operate in conjunction with wind power systems in suitable environmental and geographical conditions.

The solar power plant 18 includes one or more solar panels 18a that convert solar radiation into DC power that is provided to the VPP intelligent grid system 10. Each solar panel 18a includes one or more solar cells 18a1-3 operating together in series or parallel to guarantee the specified production capacity of the entire solar panel 18a.

The solar power plant 18 includes a controller 18b (e.g., a processor) that communicates with the VPP controller 100 to coordinate the export of power from the solar panel 18a. The controller 16b controls a power converter 18c that facilitates the export of power from the solar panel 18a and the rest of the VPP intelligent grid system 10. Note, the power flow is unidirectional. The communication link between the controller 18b and the power plant interface 118 of the VPP controller 100 is bidirectional to exchange information (e.g., solar power conversion efficiency parameters, solar panel health information, connection type/status information, weather information) and consequent control commands.

Similar to the power converter 12b, the power converter 18c may be an AC/DC power converter capable of operating in both rectified and inverter modes in order to permit power flow between the solar panel 18a and the power grid 12 of the VPP intelligent grid system 10. Furthermore, the power converter 16c may include a DC/DC power converter for voltage stepping or converting between different voltage levels of different components in the VPP intelligent grid system 10.

In general, the power converter 18c stabilizes the output voltage generated from the solar panel 18a to a prescribed DC value that is compatible with the VPP intelligent grid system 10. The power converter 18c is configured and controlled by the controller 18b to extract the maximum amount of power from the solar panel 18a at any time. The maximum extractable power from the solar panel 18a depends not only on the strength of the solar irradiation but also on the operating point of the energy conversion system. In particular, a Maximum Power Point Tracking (MPPT) system may be used to maximize system efficiency and minimizes the return of investment on the solar plant installation. Maximum power extraction may be achieved by driving DC-DC converter duty-cycle. In the considered system, a non-isolated converted may be used, where the term isolation refers to the electric barriers separating input and output of the converter. Several non-isolated DC-DC converters can be used for solar plant applications (e.g., buck, boost, and buck-boost) characterized by different topologies, operational regions, advantages, and disadvantages.

Although the VPP intelligent grid system 10 in FIG. 3A is shown as having 6 components (12, 14, 16, 18, 20 and 100), in other embodiments of the invention, a VPP intelligent grid system 10 may have more, fewer, or different components. In particular, while the above embodiments have been described with respect to a solar power plant, the present invention is not limited to this configuration and the power plant 18 may be any type of suitable power generation facility (e.g., wind power plant, hydropower plant, geothermal power plant).

The functionality of each component of the VPP intelligent grid system 10 described above may be shared among multiple instances of a single type of component (e.g., a plurality of distributed battery storage systems).

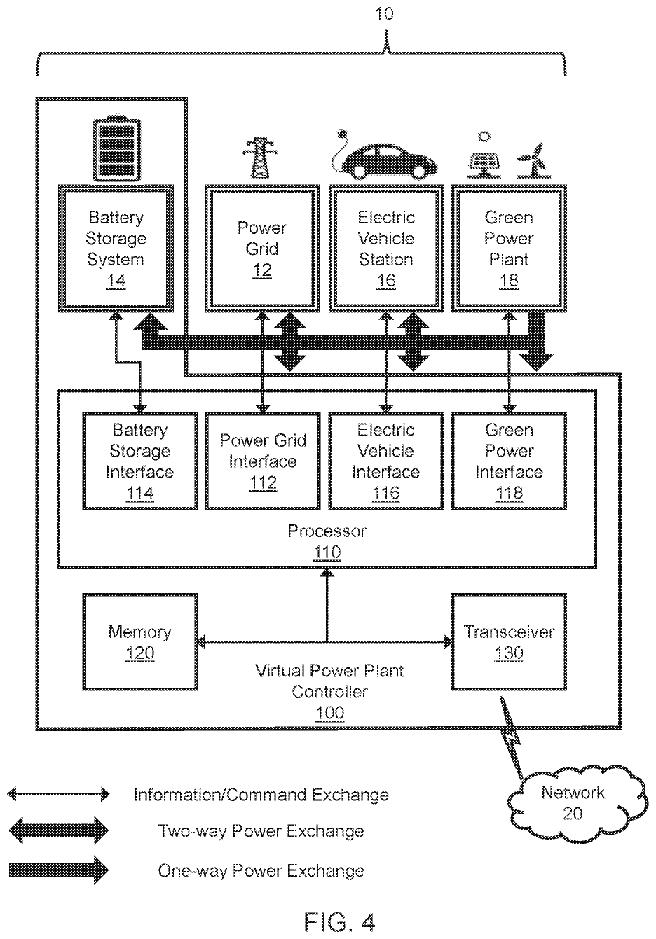

The functionality of each component of the VPP intelligent grid system 10 described above may be shared among multiple components of different types. For example, a solar power plant 18 may include an integrated battery storage system 14. As another example, FIG. 4 shows an embodiment of the VPP intelligent grid system 10 with an integrated battery storage system 14 in the VPP controller 100. In other words, the VPP controller 100 may simultaneously function as an energy management system (EMS) and as a battery management system (BMS) for the VPP intelligent grid 10.

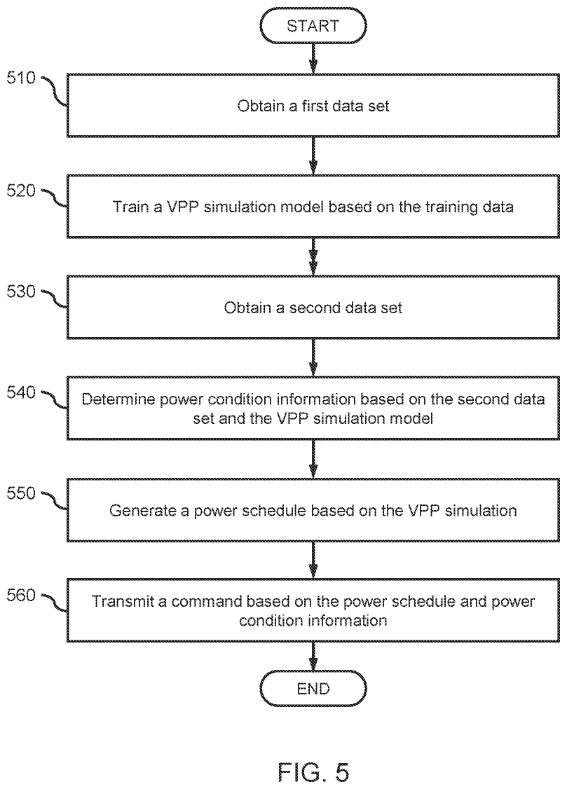

FIG. 5 shows a flowchart in accordance with one or more embodiments. One or more of the individual processes in FIG. 5 may be performed by the VPP controller 100 of FIG. 3A, as described above. One or more of the individual processes shown in FIG. 5 may be omitted, repeated, and/or performed in a different order than the order shown in FIG. 5. Accordingly, the scope of the invention should not be limited by the specific arrangement as depicted in FIG. 5.

At 510, the processor 110 of the VPP controller 100 obtains a first data set from the components of the VPP intelligent grid system 10. The first data set may include information from each of the power grid 12, the battery storage system 14, the EV charging station 16, and the power plant 18. The first data may be retrieved from each component of the VPP intelligent grid 10 by its corresponding interface of the processor 110 (i.e., the power grid interface 112 communicates with the power grid 12, the battery storage interface 114 communicates with the battery storage system 14, the EV interface 116 communicates with the EV charging station 16, and the power plant interface 118 communicates with the power plant 18).

The information from each component of the VPP intelligent grid system 10 may be historical operational information over a predetermined time period. In one or more embodiments, the first data set includes information from one or more time periods. For example, a first portion of information may provide short-term data (e.g., between one hour to one week), a second portion of information may provide medium-term data (e.g., between one week to one year), and a third portion of information may provide long-term data (e.g., more than one year).

The operational information may include power levels, maintenance schedules, connection type/status (e.g., connected to grid, disconnected from grid, connected with limited capacity, etc.), reliability reports, weather data, or any other appropriate information regarding the operation of the individual components.

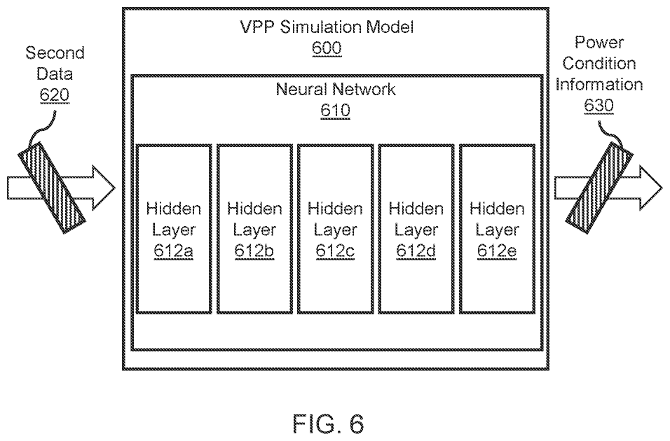

At 520, the processor 110 trains a VPP simulation model based on the first data set using a machine learning algorithm. In one or more embodiments, the VPP simulation model may be a digital twin of the physical VPP intelligent grid system 10 that emulates performance over one or more future horizons (e.g., short-term, medium-term, long-erm). The processor 110 may validate the VPP simulation model by comparing generated data (e.g., augmented, or synthetic data) to a portion of the first data set. The VPP simulation model is discussed in further detail with respect to FIG. 6 below.

At 530, the processor 110 obtains a second data set from the components of the VPP intelligent grid system 10. The second data set may include information from each of the power grid 12, the battery storage system 14, the EV charging station 16, and the power plant 18. Similar to the above, the information may be retrieved from each component of the VPP intelligent grid 10 by its corresponding interface of the processor 110.

The information in the second data set may be live operational information from each component of the VPP intelligent grid system 10. The operational information may include a current power levels, current connection type/status, equipment status/reliability reports, weather data, or any other appropriate information regarding the current operation of the individual components.

At 540, the processor 110 determines power condition information for each component of the VPP intelligent grid system 10. Based on the second data set, the processor 110 uses the VPP simulation model to determine a power condition information for each of the power grid, the battery storage system, the EV charging station, and the power plant. The power condition information may include a predictive control policy and/or an effective estimation of future dynamics of the corresponding component over a defined future horizon. For example, the power condition information may include current or predicted values of an power output/storage/consumption levels, connection status/type, connection schedule, equipment status (e.g., lifetime estimates), component replacement schedules (e.g., battery or battery cell replacement, solar panel replacement), power conversion efficiency information (e.g., solar conversion estimates based on weather models), user demand predictions, reference power levels (e.g., state of charge of a battery, maximum power grid capacity), price information (e.g., instantaneous electricity prices from one or more providers), etc. In one or more embodiments, the power condition information is defined for one or more future horizons (e.g., short-term, medium-term, long-erm).

At 550, the processor 110 generates a power schedule, based on the VPP simulation model and the power condition information. The power schedule control power exports from each of the power grid 12, the battery storage system 14, the EV charging station 16, and the power plant 18. Furthermore, the power schedule controls power imports into each of the power grid 12, the battery storage system 14, and the EV charging station 16. Note, the power schedule regulates bi-directional power flow for each of the power grid 12, the battery storage system 14, and the EV charging station 16 to balance fluctuating power demand across the system 10. For example, the unidirectional power flow out of the power plant 18 may be balanced by reducing planned capacity of the power grid 12 during peak solar production periods. In addition, the power schedule may have the battery storage system 14 schedule regular discharges to the EV charging station 16 to free up battery capacity for storing the solar power produced during peak solar production periods. Alternatively, the power schedule may prepare the battery storage system 14, the EV charging station 16, and the power plant 18 for directing all power to be injected into the power grid 12 to satisfy a predicted demand spike or take advantage of market electricity pricing conditions. These examples are for explanatory purposes only and not intended to limit the scope of the disclosed technology.

At 560, the processor 110 transmits a command to one or more components of the VPP intelligent grid system 10 to enact the power schedule. The command may be sent to cach component of the VPP intelligent grid 10 by its corresponding interface of the processor 110 (i.e., the power grid interface 112 controls the controller 12a of the power grid 12, the battery storage interface 114 controls the controller 14b of the battery storage system 14, the EV interface 116 controls the controller 16b of the EV charging station 16, and the power plant interface 118 controls the controller 18b of the power plant 18).

Each command issued by the VPP controller 100 adjusts an operation of at least one of the power grid, the battery storage system, the EV charging station, and the power plant to reduce power losses, increase power economy, and generally balance power availability across the VPP intelligent grid system 10. For example, the command may one or more of the following: an instruction to the power grid 12 to change a reference power level (e.g., a capacity threshold, a minimum/maximum operating capacity); an instruction to the battery storage system 14 to change the state of charge by charging or discharging the battery 14a (e.g., to power a particular location/facility); an instruction to the EV charging station 16 to import power to the EV (e.g.,, charge the EV during power surplus periods), pause charging, or export power from the EV (e.g., discharge the EV during peak power consumption periods); an instruction to provide power to a specific location/facility. These examples are for explanatory purposes only and not intended to limit the scope of the disclosed technology.

FIG. 6 shows an implementation example in accordance with one or more embodiments.

Generally, the VPP simulation model 600 is trained to iteratively evaluate the power flow in the VPP intelligent grid 10 and develop a control policy to achieve power regulation objectives. The suitable paradigm to be considered for developing a simulation model would be a predictive control policy, commonly termed Model Predictive Control (MPC). The main principle of MPC is to transform the control problem into an optimization one and solve this optimization problem over a prediction horizon at each sample time, subject to system dynamics, an objective function (linear or quadratic), and constraints on states, actions, and inputs. At cach control step, the optimization obtains a sequence of actions optimizing expected system behavior over the prediction horizon. Only the first step of the sequence of control actions is executed by the controller on the system until the next sample time, after which the procedure is repeated with new process measurements.

The main aspect to consider for developing an effective MPC able to satisfy previous specifications is to correctly map controller requirements into the optimization problem formulation. This would be obtained by defining the interesting dynamics and economics/control performance indices to be minimized by solving the optimization problem. Once the optimization problem is correctly formulated in a closed-form way, it would be cast in a form aided to include the prediction of dynamics of the different VPP intelligent grid components. Considering the type of MPC application, the future behavior of different virtual power plant subsystems would be evaluated by appropriate prediction algorithms.

In some embodiments, one or more machine learning algorithms are used to train a VPP simulation model 600 to accept second data 620 from VPP intelligent grid components and output power condition information 630 for each of the VPP intelligent grid components. In some embodiments, real, synthetic, and/or augmented (e.g., curated, or supplemented data) data from one or more components of the VPP intelligent grid system 10 may be combined to produce a large amount of interpreted data for training the VPP simulation model 600.

In one or more embodiments, the VPP simulation model 600 includes a deep learning neural network 610. The neural network 610 may include one or more hidden layers 612a-e (e.g., convolutional, pooling, filtering, down-sampling, up-sampling, layering, regression, dropout, etc.). In some embodiments, the number of hidden layers may be greater than or less than the five layers shown in FIG. 6. The hidden layers 612a-e can be arranged in any order.

Each hidden layer includes one or more modelling neurons. The neurons are modelling nodes or objects that are interconnected to emulate the connection patterns of the human brain. Each neuron may combine data inputs with a set of network weights and biases for adjusting the data inputs. The network weights may amplify or reduce the value of a particular data input to alter the significance of each of the various data inputs for a task that is being modeled. For example, adding a constant to a particular data input shifts the activation function for an associated task being modeled. The activation function in turn determines whether and to what extent an output of one neuron affects other neurons (e.g., one neuron output may be a weight value for use as an input to another neuron or hidden layer). Through machine learning, the neural network may determine which data inputs should receive greater priority in determining one or more specified outputs of the neural network.

For example, the VPP simulation model 600 may be trained with an objective of minimizing costs for EV charging configuration by managing charge speed and distribution in time along the day with respect to available energy power, battery capacity, and relative pricing schemes from a variety of power providers.

In one or more embodiments, the VPP simulation model 600 may be trained with an objective of minimizing infrastructure costs for solar, grid, and battery installations by extending the lifetime of equipment with optimized operational cycles. In the case of battery cost optimization, the model would emphasize calculated battery aging and loss of performance (e.g., capacity reduction over time due to temperature, calendar life, and most importantly charge/discharge power and depth of discharge). A charge-discharge profile that keeps the battery capacity far from reaching 0% and 100%, with low depth of discharge, increases dramatically the battery life (in terms of a number of charge/discharge cycles). Furthermore, the distribution of power can be controlled by price and negotiation (e.g., physically at the point use or via online application). Therefore, the VPP simulation model 600 may factor financial parameters (e.g., average income, the average cost per charge, predicted payback time, and profit) into determining power condition information. For any intelligent grid configuration, there is a minimum price or price profile for selling power to offset the financial cost of deploying the intelligent grid.

These examples are for explanatory purposes only and not intended to limit the scope of the disclosed technology.

While FIG. 6 shows an example configuration, other model configurations may be used without departing from the scope of the disclosure. For example, one or more of the individual components shown in FIG. 6 may be omitted, repeated, and/or replaced with an appropriate alternative model different from what is shown in FIG. 6. Accordingly, the scope of the invention should not be limited by the specific VPP simulation model depicted in FIG. 6.

To achieve its designed objective, the VPP simulation model may include several models related to the individual components of the VPP intelligent grid system 10.

In one or more embodiments, the VPP simulation model includes a model of the power grid 12. The model considers inputs such as power flow command signals (e.g., defined by a user or the energy management policy of the VPP controller 100) and outputs the instantaneous price of the electrical energy ($/kW.hr) and the reference constant power value to be provided by the power grid 12. Other parameters characterizing the power grid simulation model may include the reference value of electric energy from one or more providers, the maximum absolute value of the power capacity, the reference value of the power to be delivered by the power grid, a flag for activating/deactivating the power grid connection to the VPP intelligent grid system 10, and the electric energy price dynamics (e.g., expected price models based on different economic trajectories such as a constant value, a sinusoidal value, and a random value centered on the reference energy cost).

In one or more embodiments, the VPP simulation model includes a model of the battery storage system 14. The model considers inputs such as power flow command signals (e.g., defined by a user or the energy management policy of the VPP controller 100) and outputs the battery state of charge (SOC), a reference SOC (e.g., a threshold level for determining new control behavior), and the instantaneous value of the battery power. Other parameters characterizing the power grid simulation model may include the battery SOC value at the beginning of the simulation, the reference SOC, the battery power converter efficiency, the battery capacity, a switch permitting to activate/deactivate the battery connected to the VPP intelligent grid system 10, and a flag/status for defining the battery thermal dynamics (temperature effects in simulating the performance of the battery 14a and battery cells 14a1 can be considered or ignored based on the flag).

Furthermore, battery models representing lithium-ion, lithium-polymer, or lead-acid batteries can be parameterized by using manufacturer data to approximate the open-circuit voltage and the internal resistance characteristics related to battery state of charge and temperature. For example, a leakage model may be employed based on the chemical property of the batteries to characterize the amount of self-discharge. Consider the battery open circuit Eₘ and the internal resistance Rint, the battery dynamics may be described by the following equations (positive current indicates battery discharge):

$${V}_{T} = {E}_{m} + {I}_{batt} {R}_{i n t}$$

$${I}_{batt} = \frac{{I}_{i n}}{{N}_{p}}$$

$${V}_{out} = {N}_{s} {V}_{T}$$

$$S O C = \frac{1}{{Cap}_{batt}} \int {I}_{batt} dt$$

$${Ld}_{AmpHr} = \int {I}_{batt} dt$$

where I_{batt} is the battery current, Ld_{AmpHr} is the battery energy, Cap_{batt} is the battery capacity, Vₒᵤₜ is the battery voltage, Nₚ and Nₛ are the number of cells in parallel and series, respectively, Iᵢₙ is the current flowing from the battery network, and SOC is the battery state of charge. In one or more embodiments, this model may be extended to include thermal dynamic effects and/or aging effects.

In one or more embodiments, the battery storage system 14 would be modelled as a set of cells, single batteries, and/or long strings of high-capacity batteries operating as a power storage unit. This battery model is controlled by the VPP controller 100, which regulates the power flow between cells, charging and discharging phases, and other aspects related to battery management services according to battery specifications and operating conditions. The model may include additional features, such as full power battery equalization capability, battery cell disconnection capability, thermal management, protection, and fault tolerance methods or maximization of the delivered battery energy, heuristic methods (deterministic rule-based strategies), optimization methods (based on robust optimal or predictive control methods).

In one or more embodiments, the VPP simulation model includes a model of the EV charging station 16. The model considers inputs such as power flow command signals (c.g., defined by a user or the energy management policy of the VPP controller 100) and outputs the EV battery state of charge (SOC), a reference EV SOC (e.g., a threshold level for determining new control behavior), and a map of the power to be provided from/to the EV for charging/discharging operations. Other parameters characterizing the power grid simulation model may include the EV battery SOC value at the beginning of the simulation, the reference EV SOC, the EV battery power converter efficiency, the EV battery capacity, a switch permitting to activate/deactivate the connection between the EV and the VPP intelligent grid system 10, and a flag/status for defining the battery thermal dynamics (temperature effects in simulating the performance of the EV battery).

This model may be designed to maximize the EV battery life while minimizing energy cost and charging time for the owner of the EV. The model may be expanded to provide an optional online charge trade application that manages charge offering/reserve/purchase to reflect the capabilities that allow EVs to share their battery with the intelligent grid system. Therefore, the EV may be modeled as an expansion of the overall power capacity of EV charging station 16 (or the VPP intelligent grid system 10 as a whole). The model further predicts the financial benefit to the owner of the EV that participates in such a power-to-grid service and moderates the service to ensure the EV is charged for use by the owner based on the owner's usage or preference information.

In one or more embodiments, the VPP simulation model includes a model of the power plant 18. The model considers inputs such as power flow command signals (c.g., defined by a user or the energy management policy of the VPP controller 100) and outputs a reference power level value to be provided by the power plant 18. Other parameters characterizing the power plant simulation model may include the maximum absolute value of the power production capacity, the reference value of the power to be delivered by the power plant, a flag for activating/deactivating the power plant connection to the VPP intelligent grid system 10, and weather information (or relevant forecasts related to the method of energy production).

In one or more embodiments including a solar power plant, this model may mimic the series and parallel connection of several solar panels composed of photovoltaic (PV) devices (solar cells). Because the solar cells convert solar energy into electrical energy via the photovoltaic effect (generally by utilizing large-area p-n diodes that are assembled in modules (panels)), a single solar cell may be modeled as a resistor connected in series with a parallel combination of a current source consisting of a single diode with a shunt resistance structure RSH. The model simulates the photoelectric effect that converts solar energy directly into electric energy and simulates the electrical characteristics (current, voltage, and resistance) that vary based on the amount of light upon the solar cell.

One or more of the embodiments of the invention may have one or more of the following improvements to intelligent grid functionality or power management systems: the ability to monitor critical system variables (e.g., power levels, system integrity); provide real-time statistics, continuous performance tracking, alarms through a graphical user interface (GUI), shut-off commands in case of emergencies; GUI interface for the power system operators to interact with the intelligent grid network; manage communications between power subsystems; handle communication with external components and services (online charge trader, online weather data); control virtual power plant components (control the power flow with the AC grid, manage battery storage system power flow, determine energy price, manage the power dispatch scheme between virtual power plant components (e.g. EVs), evaluate battery stored energy, capacity fade (battery wearing), estimated time to service (replace batteries), adapt to customers and components power requirements); handle and adapt predictions of subsystems' behavior (e.g. energy price forecasting); calculate financial parameters (average income, the average cost per charge, predicted payback time, and profit); provide control system to adapt and optimize power flow allocation, energy price, EV charging speed/charging modality (super-fast, fast, slow, adaptive/variable), waiting times to start charging (time allocation), system operator input, a balance of energy price and EV charge speed, time of the day and resource synchronization, optimizing battery charging sequences, providing emergency energy capacity, managing energy excess, monitoring financial goal, implementing physical/logical limits on the power grid operations as defined by the operator, identifying discounts, or any combination of these aspects; providing energy negotiation modes (custom and predefined) based on the system operator and/or the user information (these modes may be fixed values provided in a table, periodically updated values (with or without waiting times), constrained modes (e.g. EV max price to pay), and adaptive charging modes given by the combination of previous modes).

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A method of managing a virtual power plant (VPP) and power distribution between a power grid, a battery storage system, an electric vehicle (EV) charging station, and a power plant, the method comprising:
obtaining a first data set including information from each of the power grid, the battery storage system, the EV charging station, and the power plant;
training a VPP simulation model based on the first data set using a machine learning algorithm;
obtaining a second data set including information from each of the power grid, the battery storage system, the EV charging station, and the power plant;
determining power condition information for each of the power grid, the battery storage system, the EV charging station, and the power plant based on the second data set and VPP simulation model;
generating a power schedule, based on the VPP simulation model and the power condition information, that controls:
power exports from each of the power grid, the battery storage system, the EV charging station, and the power plant; and
power imports into each of the power grid, the battery storage system, and the EV charging station; and
transmitting a command to adjust an operation of at least one of the power grid, the battery storage system, the EV charging station, and the power plant based on the power schedule.

2. The method of claim 1, wherein
the second data set includes the following parameters retrieved from the power grid:
a reference power level of the power grid; and
a flag indicating a connection type between the power grid and the VPP, and the command includes an instruction to the power grid to change the reference power level.

3. The method of claim 2, wherein
the second data set includes an instantaneous price of electrical energy retrieved from the power grid, and
the VPP simulation model includes a reference energy cost that is compared with the instantaneous price of the electrical energy from the power grid.

4. The method of claim 1, wherein
the second data set includes the following parameters retrieved from the battery storage system:
a state of charge of the battery storage system; and
a flag indicating a connection type between the battery storage system and the VPP, and
the command includes an instruction to the battery storage system to change the state of charge by charging or discharging the battery storage system.

5. The method of claim 4, wherein
the second data set includes a battery charge cycle number retrieved from the battery storage system, and
the VPP simulation model includes a reference battery lifetime that is compared with the battery charge cycle number from the battery storage system.

6. The method of claim 1, wherein
the second data set includes the following parameters retrieved from the EV charging station:
a connection schedule for an EV; and
a flag indicating a connection type between the EV and the VPP, and the command includes an instruction to the EV charging station to import power to the EV or export power from the EV.

7. The method of claim 6, wherein
the second data set includes a user-defined amount of power to be extracted from the EV retrieved from the EV charging station,
the VPP simulation model includes the connection schedule and the user-defined amount of power in a comparison with a state of charge of the battery storage system.

8. The method of claim 1, wherein
the second data set includes the following parameters retrieved from the power plant:
a solar power conversion efficiency parameter; and
a flag indicating a connection between the power plant and the VPP, and the command includes a target that receives power produced by the power plant.

9. The method of claim 8, wherein
the second data set includes weather information, and
the VPP simulation model includes a solar power simulation based on the solar power conversion efficiency parameter and weather information.

10. A virtual power plant (VPP) controller that manages power distribution between a power grid, a battery storage system, an electric vehicle (EV) charging station, and a power plant, the VPP controller comprising:
a processor configured as:
a power grid interface that communicates with the power grid;
a battery storage interface that communicates with the battery storage system;
an EV interface that communicates with the EV charging station; and
a power plant interface that communicates with the power plant; and
a memory storing instructions that, when executed, cause the processor to:
obtain a first data set including information from each of the power grid, the battery storage system, the EV charging station, and the power plant;
train a VPP simulation model based on the first data set using a machine learning algorithm;
obtain a second data set including information from each of the power grid, the battery storage system, the EV charging station, and the power plant;
determine power condition information for each of the power grid, the battery storage system, the EV charging station, and the power plant based on the second data set and VPP simulation model;
generate a power schedule, based on the VPP simulation model and the power condition information, that controls:
power exports from each of the power grid, the battery storage system, the EV charging station, and the power plant; and
power imports into each of the power grid, the battery storage system, and the EV charging station; and
transmit a command, via at least one of the power grid interface, the battery storage interface, the EV interface, and the power plant interface, to adjust an operation of at least one of the power grid, the battery storage system, the EV charging station, and the power plant based on the power schedule.

11. The VPP controller of claim 10, wherein
the second data set includes the following parameters retrieved from the power grid by the power grid interface:
a reference power level of the power grid; and
a flag indicating a connection type between the power grid and the VPP controller, and
the command includes an instruction to the power grid to change the reference power level.

12. The VPP controller of claim 11, wherein
the second data set includes an instantaneous price of electrical energy retrieved from the power grid by the power grid interface, and
the VPP simulation model includes a reference energy cost that is compared with the instantaneous price of the electrical energy from the power grid.

13. The VPP controller of claim 10, wherein
the second data set includes the following parameters retrieved from the battery storage system by the battery storage interface:
a state of charge of the battery storage system; and
a flag indicating a connection type between the battery storage system and the VPP controller, and
the command includes an instruction to the battery storage system to change the state of charge by charging or discharging the battery storage system.

14. The VPP controller of claim 13, wherein
the second data set includes a battery charge cycle number retrieved from the battery storage system by the battery storage interface, and
the VPP simulation model includes a reference battery lifetime that is compared with the battery charge cycle number from the battery storage system.

15. The VPP controller of claim 10, wherein
the second data set includes the following parameters retrieved from the EV charging station by the EV interface:
a connection schedule for an EV; and
a flag indicating a connection type between the EV and the VPP controller, and
the command includes an instruction to the EV charging station to import power to the EV or export power from the EV.

16. The VPP controller of claim 15, wherein
the second data set includes a user-defined amount of power to be extracted from the EV retrieved from the EV charging station by the EV interface,
the VPP simulation model includes the connection schedule and the user-defined amount of power in a comparison with a state of charge of the battery storage system.

17. The VPP controller of claim 10, wherein
the second data set includes the following parameters retrieved from the power plant by the power plant interface:
a solar power conversion efficiency parameter; and
a flag indicating a connection between the power plant and the VPP controller, and the command includes a target that receives power produced by the power plant.

18. The VPP controller of claim 17, wherein
the second data set includes weather information retrieved by the power plant interface, and
the VPP simulation model includes a solar power simulation based on the solar power conversion efficiency parameter and weather information.

19. A non-transitory computer readable medium storing instructions executable by a computer processor of a virtual power plant (VPP) that is connected to a power grid, a battery storage system, an electric vehicle (EV) charging station, and a power plant, the instructions comprising functionality for:
obtaining a first data set including information from each of the power grid, the battery storage system, the EV charging station, and the power plant;
training a VPP simulation model based on the first data set using a machine learning algorithm;
obtaining a second data set including information from each of the power grid, the battery storage system, the EV charging station, and the power plant;
determining power condition information for each of the power grid, the battery storage system, the EV charging station, and the power plant based on the second data set and VPP simulation model;
generating a power schedule, based on the VPP simulation model and the power condition information, that controls:
power exports from each of the power grid, the battery storage system, the EV charging station, and the power plant; and
power imports into each of the power grid, the battery storage system, and the EV charging station; and
transmitting a command to adjust an operation of at least one of the power grid, the battery storage system, the EV charging station, and the power plant based on the power schedule.
